(19) United States
(12) Patent Application Publication
(10) Pub. No.: US 2009/0136903 A1
(43) Pub. Date: May 28, 2009

(54) PORTABLE ATV/ DIRT BIKE/ SNOWMOBILE SAFETY TRAINER AND METHOD FOR USE

(76) Inventor: Christopher Paul McNeil, Riverton, WY (US)

Correspondence Address: AVERY ENTERPRISES, BOX 238, JOHNSTOWN, CO, 80534, US

(21) Appl. No.: 12/207,564

(22) Filed: Sep. 10, 2008

Related U.S. Application Data
(60) Provisional application No. 61/004,158, filed on Nov. 26, 2007.

(51) Int. Cl. G09B 9/02

(52) U.S. Cl. 434/29

(57) ABSTRACT

Disclosed is a portable safety trainer that can be totally controlled by an instructor and provides safety training in operating an ATV, a dirt bike or a snowmobile. The trainer uses an actual ATV, dirt bike or snowmobile as part of a course in basic safety. In one embodiment, the trainer is used in conjunction with a movie player and a screen to show students real-life examples of driving an ATV, dirt bike or snowmobile without endangering the safety of the students being trained.

### CROSS REFERENCE TO RELATED APPLICATIONS

The present invention claims the benefit of U.S. Provisional Patent Application Ser. No. 61/004,158, filed 26 Nov. 2007, entitled “All-Terrain (ATV) Safety Simulator Trainer” by Christopher Paul McNeil.

### BACKGROUND OF THE INVENTION

a. Field of the Invention

The present invention generally pertains to vehicle simulators and more particularly to all-terrain vehicle (ATV) simulators, snowmobile simulators, and dirt bike simulators.

b. Description of the Background

Trainers have been developed for most common types of vehicles to help drivers gain experience in handling vehicle controls. Such trainers are usually designed to maximize the “realism” of using the vehicle by allowing maximum driver control of the vehicle. As a result, such trainers employ extremely complicated setups to mimic each available driver control (such as brakes, gas pedal and steering wheel) and to handle every possible combination of control settings that a driver can generate. These setups may be used either for entertainment purposes (such as in a video game or amusement-park attraction) or for training (such as an airplane or automobile simulator).

Some trainers may have the “look and feel” of the vehicle they imitate but do not employ an actual vehicle. U.S. Pat. No. 6,764,310 (Ishihashi, et al.) discloses a motorcycle trainer that looks like the body of a motorcycle but does not use a real motorcycle. Other trainers that use an actual vehicle do not give control of the vehicle to an instructor. U.S. Pat. No. 5,947,739 (Lenihan) discloses a children's ride-on vehicle that can either be operated by itself or as part of a trainer. When used as part of a trainer, the driver controls the vehicle and can move it forward or backward. U.S. Pat. No. 5,209,662 (Fujita, et al.) has the look and feel of a motorcycle and can be connected to a video game to serve as a motorcycle. However, the driver still controls every aspect of the simulation; the trainer responds only to the driver's controls.

For children under 16 years of age who cannot drive a car but do operate a snowmobile in the winter or an all-terrain vehicle (ATV) or “dirt bike” motorcycle during the rest of the year, such ability to control a trainer is neither needed nor desirable. According to a 2007 Wyoming survey of 1,200 school children under age 15, nearly half do not wear a helmet when riding an ATV, nearly all ride “double” (with two people on the ATV at the same time), and nearly all admit to at least one “near-miss” accident while driving an ATV.

A person's first experience with an ATV, dirt bike or snowmobile, at any age, should be closely monitored by a qualified instructor so the person can be trained in basic safety concepts (such as wearing safety gear, including a helmet, at all times, never driving other people, and active techniques to be used by riders). Such training is safest and most effective if the instructor has total control over a trainer that contains an actual ATV, dirt bike or snowmobile. Giving an instructor total control over a trainer allows a student to concentrate only on his or her own actions and on the “feel” of the vehicle in various situations before trying to control the vehicle. Such training may allow more than one person to receive training at the same time (such as during a school class) by observing the actions of one person in the group sitting on a trainer. Thus, a portable trainer that could be moved between locations and used year-round to train people in the basic safety principles of using these vehicles without giving them control of the trainer would be useful.

In some cases, a trainer may project movies onto a screen to show examples of the situations typically encountered when driving an ATV, dirt bike or snowmobile. These movies may display good driver behavior, unsafe driver behavior or even an accident and may be shown multiple times to emphasize a safety principle.

It would therefore be advantageous to have a single portable trainer that could be used to teach snowmobile safety during the winter and ATV and dirt bike safety during the rest of the year. It would be even more advantageous if the trainer used an actual snowmobile, ATV or dirt bike as part of a course in basic safety where the instructor always maintains total control of a vehicle. It would be further advantageous for the trainer to be capable of use in conjunction with movies played on a screen to show real-life examples of driving an ATV, dirt bike or snowmobile without endangering the safety of the students being trained.

### SUMMARY OF THE INVENTION

The present invention overcomes the disadvantages and limitations of the prior art by providing a portable safety trainer that may be totally controlled by an instructor and adjusted to support a real ATV, dirt bike or snowmobile. The trainer may help an instructor to provide training in the safe use of these vehicles. In some embodiments, a movie player and screen may be used to improve training quality.

The present invention may thus comprise a portable device for training at least one student in the basic safety methods of operating a vehicle, comprising: a vehicle that may be mounted by a student; a vehicle support unit that supports a vehicle support receiver hitch, is supported by a metallic ball, and maneuvers and helps to support the weight of the vehicle during training; a vehicle support platform on which the vehicle is mounted and supported and maneuvered by the vehicle support unit; at least one cylinder that is supported by a hitch, supports a metallic ball, and can be adjusted to control the side-to-side pivoting of the vehicle during training while the vehicle is maneuvered by the vehicle support unit on the vehicle support platform; at least one cylinder that is supported by a hitch, supports a metallic ball, and can be adjusted to control the uphill/downhill pivoting of the vehicle during training while the vehicle is maneuvered by the vehicle support unit on the vehicle support platform; a set comprising at least one directional controller that controls the movement and position of the cylinders that control the side-to-side pivoting and the uphill/downhill pivoting of the vehicle while the vehicle is maneuvered by the vehicle support unit on the vehicle support platform; a power unit that controls the cylinders and the set comprising at least one directional controller; a safety control that provides electric power to the power unit and, when non-operational, may prevent electric power from reaching the power unit and the subsequent activation of the set comprising at least one directional controller; a removable tow hitch that allows connection of a trailer to the portable device and allows the trailer to move the portable device; a wheel unit that attaches to the underside of the portable device, controls the position of at least one wheel on the underside of the portable device, and allows the portable device to be moved when the wheels are touching the ground and the portable device is connected to a trailer by the removable tow hitch; and, a storage box within the vehicle support platform that holds miscellaneous equipment related to the portable device and to the vehicle.

The device may further comprise a set of signs for advertising purposes that attach to the facing sides of the vehicle support platform. The device may further comprise a movie player that attaches to the vehicle support platform and plays movies showing typical scenes encountered while driving the vehicle. The device may further comprise a screen that attaches to the vehicle support platform and displays the movies to students. The cylinders, set comprising at least one directional controller, and power unit may be hydraulically or pneumatically controlled. The metallic vehicle support unit and metallic vehicle support platform may be made of metal (such as aluminum) or a metallic compound (such as steel). The vehicle may be an all-terrain vehicle (ATV), a “dirt bike” motorcycle or a snowmobile that requires a support table made of metal (such as aluminum) or a metallic compound (such as steel) that attaches underneath the snowmobile and supports the snowmobile on the vehicle support platform.

The present invention may therefore comprise a method of training at least one student in the basic safety methods of operating a vehicle, comprising: use of an instructor qualified in teaching the basic safety methods of operating the vehicle to teach basic safety methods of operating the vehicle to the student; use of basic safety equipment to be worn by the student during training; and, use of a portable device that can train at least one student in the basic safety methods of operating the vehicle.

The portable device may comprise: a vehicle that may be mounted by a student; a metallic vehicle support unit that supports a vehicle support receiver hitch, is supported by a metallic ball, and maneuvers and helps to support the weight of the vehicle during training; a metallic vehicle support platform on which the vehicle is mounted and supported and maneuvered by the vehicle support unit; at least one cylinder that is supported by a hitch, supports a metallic ball, and can be adjusted to control the side-to-side pivoting of the vehicle during training while the vehicle is maneuvered by the vehicle support unit on the vehicle support platform; at least one cylinder that is supported by a hitch, supports a metallic ball, and can be adjusted to control the uphill/downhill pivoting of the vehicle during the training while the vehicle is maneuvered by the vehicle support unit on the vehicle support platform; a set comprising at least one directional controller that controls the movement and position of the cylinders that control side-to-side pivoting and uphill/downhill pivoting of the vehicle while the vehicle is maneuvered by the vehicle support unit on the vehicle support platform; a power unit that controls the cylinders and the set comprising at least one directional controller; a safety control that provides electric power to the power unit and, when non-operational, may prevent electric power from reaching the power unit and the subsequent activation of the set comprising at least one directional controller; a removable tow hitch that allows connection of a trailer to the portable device and allows the trailer to move the portable device; a wheel unit that attaches to the underside of the portable device, controls the position of at least one wheel on the underside of the portable device, and allows the portable device to be moved when the wheels are touching the ground and the portable device is connected to a trailer by the removable tow hitch; and, a storage box within the vehicle support platform that holds miscellaneous equipment related to the portable device and to the vehicle.

The device may further comprise a set of signs for advertising purposes that attach to the facing sides of the vehicle support platform. The device may further comprise a movie player that attaches to the vehicle support platform and plays movies showing typical scenes encountered while driving the vehicle. The device may further comprise a screen that attaches to the vehicle support platform and displays the movies to students. The cylinders, set comprising at least one directional controller, and power unit may be hydraulically or pneumatically controlled. The metallic vehicle support unit and metallic vehicle support platform may be made of metal (such as aluminum) or a metallic compound (such as steel). The vehicle may be an all-terrain vehicle (ATV), a “dirt bike” motorcycle or a snowmobile that requires a support table made of metal (such as aluminum) or a metallic compound (such as steel) that attaches underneath the snowmobile and supports the snowmobile on the vehicle support platform.

The advantages of the present invention are: 1) students do not have to worry about controlling a vehicle during safety training because an instructor always controls the vehicle, 2) the safety trainer is portable and can be used in conjunction with a real ATV, a real dirt bike or a real snowmobile, and 3) a movie player and screen may be used in conjunction with the safety trainer to improve training quality.

### BRIEF DESCRIPTION OF THE DRAWINGS

In the drawings,

FIG. 1 is a view of a vehicle support unit from above, which is a part of the present invention.

FIG. 2 is a front view of the vehicle support unit.

FIG. 3 is an internal view of the present invention from above.

FIG. 4 is a side view of one embodiment of the present invention that may be used in ATV safety training.

FIG. 5 is a side view of another embodiment of the present invention that may be used in snowmobile safety training.

FIG. 6 is a side view of yet another embodiment of the present invention that may be used in ATV safety training and utilizes a movie player and a screen.

### DETAILED DESCRIPTION OF THE INVENTION

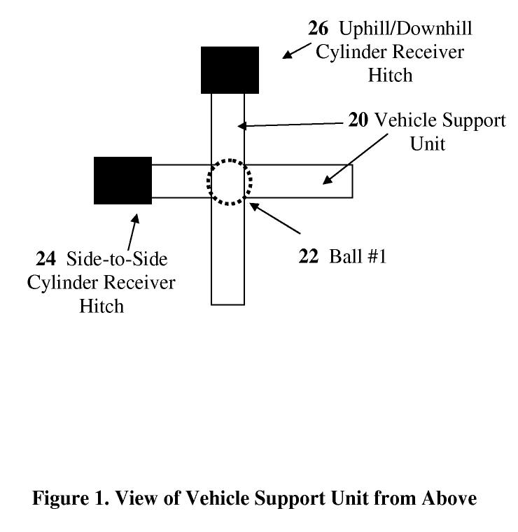

The present invention may hold the entire weight of an ATV, a dirt bike or a snowmobile without being damaged or deformed. FIG. 1 shows, from above, a vehicle support unit 20 that is an integral part of the present invention. The vehicle support unit 20 may contain a horizontal beam and a vertical beam that are the same length and are connected to each other in the shape of a cross. Both beams may be made of a metal (such as aluminum) or of a metallic compound (such as steel) to help support the weight of a vehicle without being damaged or deformed.

A ball #1 22 may be attached to the underside of the vehicle support unit 20 at the point where the horizontal beam and vertical beam connect to each other. A side-to-side cylinder receiver hitch 24 may be connected to, pinned to or built into the horizontal beam of the vehicle support unit 20 and may hold a cylinder that can be adjusted to move a vehicle from side to side with respect to the driver's position while sitting on the vehicle. An uphill/downhill cylinder receiver hitch 26 may likewise be connected to, pinned to or built into the vertical beam of the vehicle support unit 20 and may hold a cylinder that can be adjusted to move a vehicle into an uphill or downhill position with respect to the driver's position while sitting on the vehicle. Both cylinders may move the vertical support unit 20, and the vehicle may move in the same direction as the vertical support unit 20 moves.

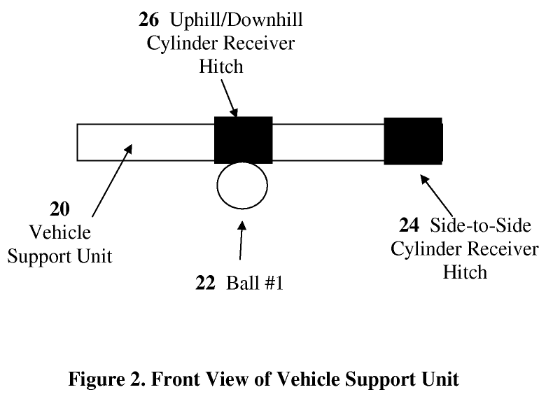

FIG. 2 shows a front view of the vehicle support unit 20. In this view, ball #1 22 may be seen underneath the center of the vehicle support unit 20. Ball #1 22 allows the center of a vehicle to pivot in all directions. The side-to-side cylinder receiver hitch 24 and uphill/downhill cylinder receiver hitch 26 may also be seen from the front.

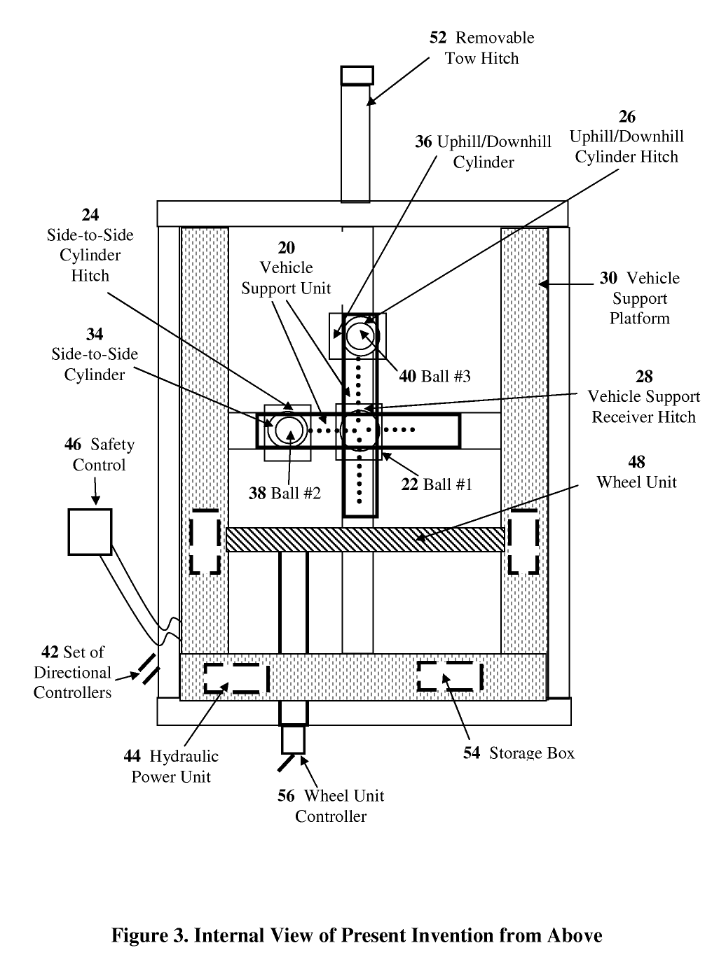

FIG. 3 illustrates an internal view of the present invention from above. A vehicle support platform 30 may surround the vehicle support unit 20 on all sides and further support the weight of a vehicle while the vehicle is mounted on the vehicle support platform 30. The vehicle support platform 30 may not necessarily have any connection points to the vehicle support unit 20. A vehicle support receiver hitch 28 may hold ball #1 22 that is on the underside of the vehicle support unit 20 as shown in FIG. 1. While the vehicle support receiver hitch 28 holds ball #1 22, a vehicle mounted on the vehicle support platform 30 and supported by the vehicle support unit 20 may have its position changed by a side-to-side cylinder 34 and an uphill/downhill cylinder 36 that are respectively supported by the side-to-side cylinder receiver hitch 24 and the uphill/downhill cylinder receiver hitch 26. The side-to-side cylinder 34 and uphill/downhill cylinder 36 may be underneath of and support (respectively) ball #2 38 and ball #3 40 that support some of a vehicle's weight and allow pivoting of the vehicle on ball #1 22 as desired. The side-to-side cylinder 34 and uphill/downhill cylinder 36 may be bi-directional controls or hydraulic spools that allow vehicle pivoting in all four directions (up, down, left and right). Movement of the side-to-side cylinder 34 and the uphill/downhill cylinder 36 may cause the vertical support unit 20 to move in the same direction, and the movement of the vertical support unit 20 causes the vehicle to move in the same direction.

The vehicle support platform 30 may rest on the ground and may typically be made of a metal (such as aluminum) or of a metallic compound (such as steel) because it must be strong enough (in combination with the vehicle support unit 20, ball #1 22, side-to-side cylinder receiver hitch 24, uphill/downhill cylinder receiver hitch 26, vehicle support receiver hitch 28, side-to-side cylinder 34, uphill/downhill cylinder 36, ball #2 38 and ball #3 40) to support the entire weight of an ATV, dirt bike or snowmobile without deforming. The three balls 22, 38 and 40 may be made of a metal or metallic compound, similar to a ball used with a trailer hitch, and may be securely placed so that they cannot fall off their respective supports.

The vehicle support receiver hitch 28, which is mounted on ball #1 22 so that ball #1 28 may be raised vertically above the vehicle support platform 30, may allow ball #1 22 to rotate so that when ball #1 22 has a vehicle resting on it, the vehicle may undergo both a maximum side-to-side angle of approximately 30° created by the side-to-side cylinder 34 and ball #2 38 (to either the left or the right) and a simultaneous maximum uphill/downhill angle of approximately 30° created by the uphill/downhill cylinder 36 and ball #3 40 (either forward or backward). Different side-to-side cylinders 34 or uphill/downhill cylinders 36 may be used as desired to move the vertical support unit 20 and give different maximum angles of movement for the given vehicle. For safe training of adults, the maximum angle in each direction is approximately 25°-30°; for safe training of children, the maximum angle in each direction is approximately 15°-20°.

The side-to-side cylinder 34 and ball #2 38 control the side-to-side pivoting of a vehicle on the vehicle support platform 30; when the side-to-side cylinder 34 and ball #2 38 cause ball #1 32 to rotate until the left side of an ATV is lower to the ground than the right side of an ATV, the effect is to make a person in the seat of an ATV feel as if he is making a banking turn to the left. When the side-to-side cylinder 34 and ball #2 38 causes ball #1 32 to rotate until the right side of an ATV is lower to the ground than the left side of an ATV, the effect is to make a person in the seat of an ATV feel as if he is making a banking turn to the right.

The uphill/downhill cylinder 36 and ball #3 40 control the front-to-back pivoting of an ATV on the vehicle support platform 30; when the uphill/downhill cylinder 36 and ball #3 40 cause ball #1 32 to rotate until the front of an ATV is lower to the ground than the rear of an ATV, the effect is to make a person in the seat of an ATV feel as if he is moving downhill. When the uphill/downhill cylinder 36 and ball #3 40 cause ball #1 32 to rotate until the rear of an ATV is lower to the ground than the front of an ATV, the effect is to make a person in the seat of an ATV feel as if he is moving uphill. The cylinder/ball combinations 34/38 and 36/40 may be used simultaneously to pivot an ATV in any desired combination of directions.

The positions of the side-to-side cylinder 34 and uphill/downhill cylinder 36 are adjusted by a set of directional controllers 42 that is connected to a hydraulic power unit 44. The hydraulic power unit 44 may be activated only when a safety control 46 is also activated. The hydraulic power unit 44 may also be connected to an electrical outlet that may power the safety control 46. Other embodiments of the present invention may use pneumatic power in place of the hydraulic power unit 44 and to operate the set of directional controllers 42. However, research indicates that electrical actuators may not have enough physical strength to be used in the present invention.

One controller in the set of directional controllers 42 may be connected to the side-to-side cylinder 34, while another controller in the set of directional controllers 42 may be connected to the uphill/downhill cylinder 36. The side-to-side cylinder 34, uphill/downhill cylinder 36 and set of directional controllers 42 may be connected to the hydraulic power unit 44 by hoses and other connectors. An instructor may use the set of directional controllers 42 (while the safety control 46 is activated) to rotate a vehicle to a desired degree of pitch and/or roll and keep the vehicle in that position for as long as the instructor thinks necessary. The student sitting in the seat of the vehicle thus has no control over the vehicle of the ATV, though the vehicle's handlebars or directional controls may be used to turn the front wheels or front section of the vehicle very slightly to the left or right.

The safety control 46 may be an electric foot pedal under control of an instructor and may typically be unnoticed by a student sitting on the seat of a vehicle during safety instruction. While the safety control 46 remains inactivated, the set of directional controllers 42 may be immovable, keeping a vehicle in its current position and reducing the likelihood of student injury due to a sudden change in vehicle position. The safety control 46 may not be left “on” when not in use because onlookers may use the set of directional controllers 42 to disturb the vehicle setting during training and because prolonged operation of the safety control 46 may overheat hydraulic fluid within the hydraulic power unit 44. When an instructor is ready to change the vehicle position, he may inform a student sitting on the seat of the vehicle that the vehicle will now change positions and ensure that the student is holding onto the vehicle's handlebars. The instructor may then activate the safety control 46 with his foot and, while his foot remains engaged with the safety control 46, adjust the set of directional controllers 42 as desired. The set of directional controllers 42 adjusts the settings of the hydraulic power unit 44, causing adjustments in the positions of the side-to-side cylinder 34 and uphill/downhill cylinder 36 that move the vertical support unit 20 into an ATV position desired by the instructor that is maintained by the vehicle receiver support hitch 28 and ball #1 22.

When the present invention is to be used for safety training, a retractable wheel unit 48 (partly shown by dashed lines in FIG. 3) may be adjusted by a wheel unit controller 50 until the wheels of the retractable wheel unit 48 are off the ground and not supporting any weight of the vehicle support platform 30. The axle shown as part of the retractable wheel unit 48 may pivot as needed to allow the wheels to be lifted off the ground. The present invention is thus placed in a stable position for the duration of the safety training.

When safety training is completed, the present invention may either be moved a short distance to another location or loaded onto a trailer to be moved for longer distances. When moving the present invention a short distance (less than approximately one-quarter mile), the wheel unit controller 50 may adjust the retractable wheel unit 48 until the wheels are on the ground underneath the vehicle support platform 30. An ATV or automobile may then be attached to a removable tow hitch 52 to move the present invention to another location on the wheels of the retractable wheel unit 48 (at a maximum speed of approximately 5 miles per hour). When moving the present invention a distance longer than approximately one-quarter mile, the present invention may be loaded onto a trailer. Thus, the present invention is portable and can be moved from one location to another as desired to conduct safety training in various locations. A storage box 54 may be used to store miscellaneous equipment related to the portable device and to the vehicle and may contain a lid to prevent equipment loss.

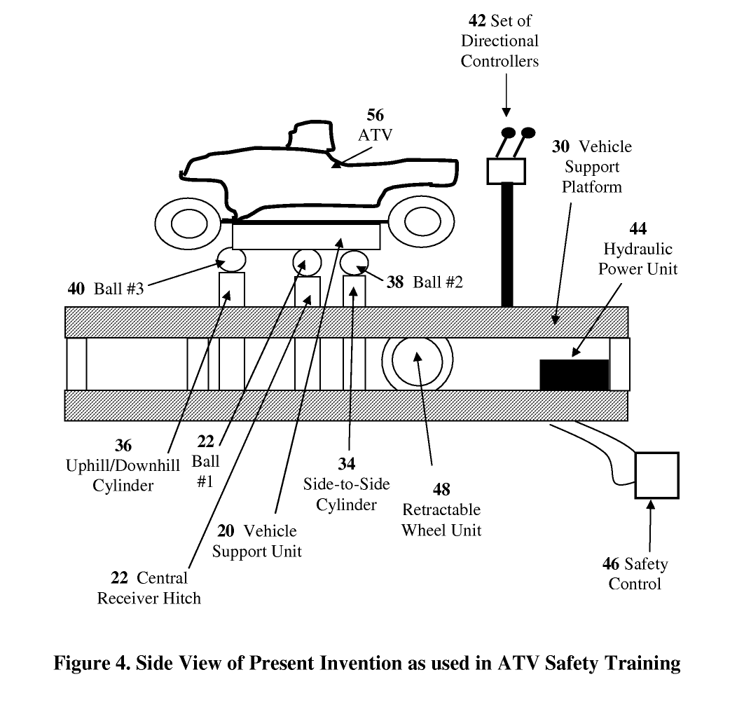

FIG. 4 illustrates a side view of one embodiment of the present invention as used in ATV safety training and without the removable tow hitch 52 attached. The retractable wheel unit 48 is adjusted so that the wheels do not touch the ground. The uphill/downhill cylinder 36, ball #3 40, side-to-side cylinder 34 and ball #2 38 can all be seen. In FIG. 4, the side view is slightly modified so that the central receiver hitch 28, vehicle support unit 20 and ball #1 22 can be seen; in typical embodiments, these three objects are in the same horizontal position as the side-to-side cylinder 34 and ball #2 38 and thus cannot be seen from a side view.

The height of the vehicle support platform 30 off the ground may allow a student to step from the ground onto the vehicle support platform 30 and then onto an ATV 56 that is mounted on the vehicle support platform 30 on top of the vehicle support unit 20. The vehicle support unit 20 is supported by ball #2 38, ball #3 40 and ball #1 22.

A student may assume a seated position on the ATV 56 as if actually driving the ATV 56. Before safety training begins, an instructor may provide introductory training in such areas as trip planning, basic ATV inspection, wearing basic safety gear (such as a helmet), and ensuring that a student is the proper size to ride the ATV 56 (as giving a student an ATV that is either too large or too small for the student to safely ride is very dangerous). The instructor controls the posit ion of the ATV 56 on the vehicle support platform 30 with the set of directional controllers 42 and safety control 46 as powered by the hydraulic power unit 44. The instructor may set the position of the ATV 56 to simulate uphill conditions, downhill conditions, cornering, and transverse (or banked) turns. In each of these situations commonly faced while driving an ATV, a student may be trained on how to shift his or her body weight on the seat of the ATV 56 to maintain control (or “rider activeness”) of the ATV 56 and prevent the ATV 56 from tipping over. The ATV 56 may be set in a given position and left there for several minutes while a student listens to the instructor, becomes accustomed to the “feeling” of the ATV 56 in that position, and practices shifting his body weight to control the ATV's center of gravity and prevent rollover of the ATV 56. A student may also be instructed never to allow two people to ride an ATV at the same time.

In another embodiment of the present invention, a “dirt bike” motorcycle may be mounted on the vehicle support platform 30 and used in training, in the same manner as the ATV 56 is supported on the vehicle support platform 30 in FIG. 4. Safety training in dirt bike operation may thus be given in a manner similar to the training given for operating the ATV 56.

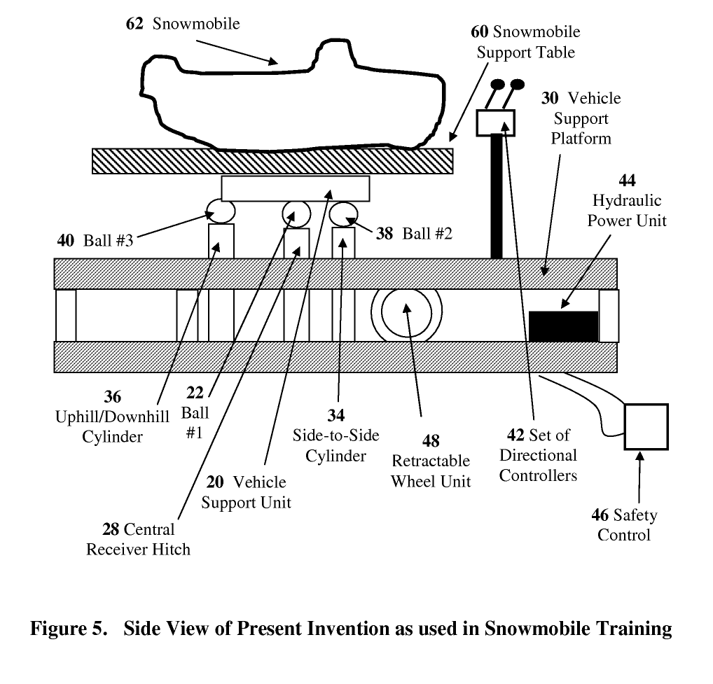

The present invention may further be adapted to support a snowmobile and provide training in snowmobile operation. FIG. 5 illustrates a side view of another embodiment of the present invention that may be used in snowmobile safety training. A snowmobile support table 60 that is strong enough to support much of the weight of a snowmobile 62 without deforming may be attached to the vehicle support platform 30 on top of the vehicle support unit 20. Bolts, brackets or other connectors may be used to keep the snowmobile 62 firmly attached to the snowmobile support table 60 and prevent the snowmobile 62 from sliding on the snowmobile support table 60 while it is controlled by a safety instructor with the set of directional controllers 42, safety control 46 and hydraulic power unit 44. The snowmobile may face the rear of the vehicle support platform 30, instead of facing the front of the vehicle support platform 30 as an ATV does when supported by the present invention.

As with the ATV shown in FIG. 4, the uphill/downhill cylinder 36, ball #3 40, side-to-side cylinder 34 and ball #2 38 maneuver the vehicle support unit 20 that moves the snowmobile on the vehicle support platform 30 into a given position. As with FIG. 4, the side view is slightly modified to show the vehicle support unit 20, central receiver hitch 28 and ball #1 22. The snowmobile may undergo both a maximum uphill/downhill angle of approximately 30° (either forward or back ward) and a simultaneous maximum side-to-side angle of approximately 30° (to either the left or the right). An instructor may adjust the position of the snowmobile 62 on top of the snowmobile support table 60 to set the snowmobile 62 in a desired position and keep the snowmobile 62 in that position for as long as the instructor thinks necessary, similar to the manner in which an ATV's position is adjusted during training. The student sitting in the seat of the snowmobile 62 thus has no control over the snowmobile 62, though the snowmobile's steering wheel may be used to turn the front section of the vehicle very slightly to the left or right.

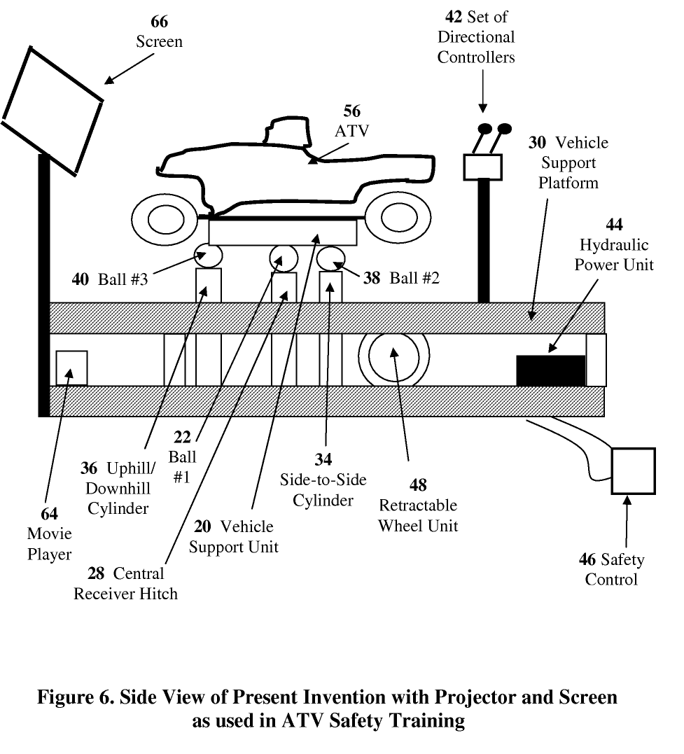

FIG. 6 illustrates yet another embodiment of the present invention that may augment ATV safety training by the addition of a movie player 64 and a screen 66 to the vehicle support platform 30. The movie player 64 may play movies (such as from a CD or DVD) of an outdoor scene that may be displayed on the screen 66 to give a student sitting on the ATV 56 (or a dirt bike) an illusion of moving through an outdoor area where the ATV 56 (or dirt bike) may be driven. In some embodiments, the movie player 64 may be operated by a computer under the control of an instructor that may stop and rewind the movie as desired during training. In other embodiments, the outdoor scene may be captured by GPS and then loaded into the movie player 64 and shown on the screen 66. The ATV 56 (or dirt bike) remains under the control of an instructor, using the set of directional controllers 42 and safety control 46; the student has no control over the vehicle's position on the vehicle support platform 30.

The screen 66 may be the size of a typical “big screen” television screen and may be pivoted up to 90° to the left and right from the middle of the vehicle support platform 30, allowing multiple students to see a movie played on the screen 66 even though only one student is on the ATV 56 (or dirt bike). A movie played on the screen 66 only contains examples of good (or bad) A TV safety practice; the movie is not changed in any way by student actions while sitting on the ATV 56.

Though FIG. 6 shows the screen 66 at the front of the vehicle support platform 30, alternate embodiments may place the screen 66 at the rear of the vehicle support platform 30 to accommodate snowmobile training, as FIG. 5 shows the front of the snowmobile 62 facing the rear of the vehicle support platform 30 and students must still be able to see the screen 66.

A set of signs may also be attached to the four facing sides of the vehicle support platform 30. The set of signs may be used for advertising purposes and to illustrate or display the purpose of the present invention (as an advertisement to passersby at a fair, for example). The front sign of the set of signs may be removed as needed to provide space for the movie player 64 and screen 66.

The present invention therefore provides a single portable trainer for teaching snowmobile safety during the winter and ATV and dirt bike safety during the rest of the year, particularly to schoolchildren under age 16. The trainer uses an actual snowmobile, ATV or dirt bike as part of a course in basic safety where the instructor always maintains total control over the vehicle in use. The trainer is capable of use in conjunction with a movie player and a screen to improve training quality by showing real-life examples of an ATV, dirt bike or snowmobile being driven without endangering the safety of students being trained.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A portable device for training at least one student in the basic safety methods of operating a vehicle, comprising:
a vehicle that may be mounted by a student;
a vehicle support unit that supports a vehicle support receiver hitch, is supported by a metallic ball, and maneuvers and helps to support the weight of said vehicle during said training;
a vehicle support platform on which said vehicle is mounted and supported and maneuvered by said vehicle support unit;
at least one cylinder that is supported by a hitch, supports a metallic ball, and can be adjusted to control the side-to-side pivoting of said vehicle during said training while said vehicle is maneuvered by said vehicle support unit on said vehicle support platform;
at least one cylinder that is supported by a hitch, supports a metallic ball, and can be adjusted to control the uphill/downhill pivoting of said vehicle during said training while said vehicle is maneuvered by said vehicle support unit on said vehicle support platform;
a set comprising at least one directional controller that controls the movement and position of said cylinders that control said side-to-side pivoting and said uphill/downhill pivoting of said vehicle while said vehicle is maneuvered by said vehicle support unit on said vehicle support platform;
a power unit that controls said cylinders and said set comprising at least one directional controller;
a safety control that provides electric power to said power unit and, when non-operational, may prevent electric power from reaching said power unit and the subsequent activation of said set comprising at least one directional controller;
a removable tow hitch that allows connection of a trailer to said portable device and allows said trailer to move said portable device;
a wheel unit that attaches to the underside of said portable device, controls the position of at least one wheel on the underside of said portable device, and allows said portable device to be moved when said wheels are touching the ground and said portable device is connected to an ATV or automobile by said removable tow hitch; and,
a storage box within said vehicle support platform that holds miscellaneous equipment related to said portable device and to said vehicle.

2. The portable device of claim 1, further comprising a set of signs for advertising purposes that attach to the facing sides of said vehicle support platform.

3. The portable device of claim 1, further comprising a movie player that attaches to said vehicle support platform and plays movies showing typical outdoor scenes encountered while driving said vehicle.

4. The portable device of claim 3, further comprising a screen that attaches to said vehicle support platform and displays said movies to said students.

5. The portable device of claim 1, wherein said cylinders, said set comprising at least one directional controller and said power unit are hydraulically or pneumatically controlled.

6. The portable device of claim 1, wherein said vehicle support unit and said vehicle support platform are made of metal (such as aluminum) or a metallic compound (such as steel).

7. The portable device of claim 1, wherein said vehicle is an all-terrain vehicle (ATV) or “dirt bike” motorcycle.

8. The portable device of claim 1, wherein said vehicle is a snowmobile.

9. The portable device of claim 8, further comprising a support table that attaches underneath said snowmobile and supports said snowmobile on said vehicle support platform.

10. The portable device of claim 9, wherein said support table is made of metal (such as aluminum) or a metallic compound (such as steel).

11. A method of training at least one student in the basic safety methods of operating a vehicle, comprising:
use of an instructor qualified in teaching said basic safety methods of operating said vehicle to teach said basic safety methods of operating said vehicle to said student;
use of basic safety equipment to be worn by said student during said training; and,
use of a portable device that can train at least one student in said basic safety methods of operating said vehicle.

12. The method of claim 11, wherein said portable device comprises:
a vehicle that may be mounted by a student;
a vehicle support unit that supports a vehicle support receiver hitch, is supported by a metallic ball, and maneuvers and helps to support the weight of said vehicle during said training;
a vehicle support platform on which said vehicle is mounted and supported and maneuvered by said vehicle support unit;
at least one cylinder that is supported by a hitch, supports a metallic ball, and can be adjusted to control the side-to-side pivoting of said vehicle during said training while said vehicle is maneuvered by said vehicle support unit on said vehicle support platform;
at least one cylinder that is supported by a hitch, supports a metallic ball, and can be adjusted to control the uphill/downhill pivoting of said vehicle during said training while said vehicle is maneuvered by said vehicle support unit on said vehicle support platform;
a set comprising at least one directional controller that controls the movement and position of said cylinders that control said side-to-side pivoting and said uphill/downhill pivoting of said vehicle while said vehicle is maneuvered by said vehicle support unit on said vehicle support platform;
a power unit that controls said cylinders and said set comprising at least one directional controller;
a safety control that provides electric power to said power unit and, when non-operational, may prevent electric power from reaching said power unit and the subsequent activation of said set comprising at least one directional controller;
a removable tow hitch that allows connection of a trailer to said portable device and allows said trailer to move said portable device;
a wheel unit that attaches to the underside of said portable device, controls the position of at least one wheel on the underside of said portable device, and allows said portable device to be moved when said wheels are touching the ground and said portable device is connected to an ATV or automobile by said removable tow hitch; and,
a storage box within said vehicle support platform that holds miscellaneous equipment related to said portable device and to said vehicle.

13. The method of claim 11, wherein said portable device further comprises a set of signs for advertising purposes that attach to the facing sides of said vehicle support platform.

14. The method of claim 11, wherein said portable device further comprises a movie player that attaches to said vehicle support platform and plays movies showing typical outdoor scenes encountered while driving said vehicle.

15. The method of claim 14, wherein said portable device further comprises a screen that attaches to said vehicle support platform and displays said movies to said students.

16. The method of claim 11, wherein said cylinders, said set comprising at least one directional controller and said power unit are hydraulically or pneumatically controlled.

17. The method of claim 11, wherein said vehicle support unit and said vehicle support platform are made of metal (such as aluminum) or a metallic compound (such as steel).

18. The method of claim 11, wherein said vehicle is an all-terrain vehicle (ATV) or “dirt bike” motorcycle.

19. The method of claim 11, wherein said vehicle is a snowmobile.

20. The method of claim 19, further comprising a support table that is made of metal (such as aluminum) or a metallic compound (such as steel), attaches underneath said snowmobile, and supports said snowmobile on said vehicle support platform.
